(19) United States
(12) Patent Application Publication
(10) Pub. No.: US 2006/0274029 A1
(43) Pub. Date: Dec. 7, 2006

(54) Mobile device and display

(75) Inventors: I-Wei Hong, Taipei City (TW); Chien-Chih Chen, Hsinchu County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/211,377

(22) Filed: Aug. 25, 2005

(30) Foreign Application Priority Data
Jun. 6, 2005 (TW) 94118650

(51) Int. Cl. G09G 3/36

(52) U.S. Cl. 345/104

(57) ABSTRACT

A display includes a substrate, a pixel array and an application specific integrated circuit (ASIC). The substrate has a display region. The pixel array is formed on the display region, and constituted by several mutual parallel scan lines and several parallel data lines. The data lines intersect with the scan lines. The ASIC is positioned along an extending direction of the scan lines.

This application claims the benefit of Taiwan Application Serial No. 094118650, filed Jun. 06, 2005, the subject matter of which is incorporated herein by reference.

### BACKGROUND OF THE INVENTION

1. Field of the Invention

The invention relates in general to a mobile device and the display thereof, and more particularly to a mobile device and the display having slim boarder thereof whose internal components are effectively arranged so as to contract the border and further reduce the size of the mobile device.

2. Description of the Related Art

With the maturity in the technology of wireless communication, mobile communication devices such as mobile phone, digital still camera, and personal digital assistant (PDA) in particularity have become mainstream products. Mobile devices highly emphasize the features such as slimness, compactness, smallness and lightweight.

FIG. 1A is a diagram of a conventional display adopting an amorphous silicon (a-Si) manufacturing process. Conventional display 10 includes a substrate 11, a gate driver 12 and a source driver 13. The substrate 11 has a display region 11a, a pixel array formed by several scan lines and several data lines intersecting the scan lines, and several thin film transistors formed on the display region and positioned in the pixel array. Drive circuits such as the gate driver 12 and the source driver 13 are respectively packaged as IC chips first, and then disposed on the part of the substrate 11 other than the display region 11a by chip on glass (COG) process.

FIG. 1B is a front view of a conventional mobile device having a display shown in FIG. 1A. Conventional mobile device 19 includes a display region 11a and an operating panel 18. The operating panel 18 is disposed at the right-hand side of the display region 11a. The left-hand side border of the display is corresponding to the gate driver 12 of FIG. 1A. The bottom border of the display is corresponding to the source driver 13 of FIG. 1A.

As shown in FIG. 1B, the gate driver 12 and the source driver 13 of the conventional display 10 are packaged IC chips, thus occupying a larger area and making the display region 11a farther away from the edge of the substrate 11. Besides, the four borders of the display are extremely asymmetric, severely jeopardizing exterior design of product. Particularly, when it comes to mobile communication devices to which the features of slimness, lightweight, and compactness are important, once the disposition of internal drive circuits of conventional display is augmented, the product size would inevitably be enlarged accordingly, severely affecting competitiveness of product.

FIG. 2 is a diagram of the conventional display adopting a low-temperature polycrystalline silicon manufacturing process. Conventional display 100 includes a substrate 110, a gate driver 120, a switch 130, a flexible circuit board 140 and a source driver 150. The substrate 110 has a display region 111, a pixel array formed by several scan lines and several data lines intersecting the scan lines, and several thin film transistors formed on the display region and positioned in the pixel array. Drive circuits such as the gate driver 120 and the switch 130 are disposed on the part of the substrate other than the display region 110. Part of simple circuits such as the gate driver 120 and the switch 130 can be formed on the substrate according to low-temperature polycrystalline silicon (LTPS) manufacturing process when manufacturing thin film transistors. Drive circuits such as the gate driver 120 and the switch 130 are not packaged and occupy a smaller amount of volume, so the required space can be further reduced.

The conventional display 100 adopts a 3-point-at-a-time (3-PAAT) driving method. That is, the conventional display 100 uses an external source driver 150 to output three analogue voltage signals and three time sequence control signals. The signals are transmitted to the switch 130 and the gate driver 120 via the flexible circuit board 140, so as to drive the pixel array to form an image in the display region 111.

However, the conventional display 100 adopting the low-temperature polycrystalline silicon manufacturing process directly forms the circuits of the gate driver 120 and the switch 130 on the substrate, decreasing the yield rate in the manufacturing process of display panel. Further, the conventional display 100 uses an external source driver 150 according to the 3-PAAT driving method, so that the switch must be operated under a higher operating frequency, and inherently cause the accelerated deterioration of the display panel.

Therefore, how to improve both the space utilization of the mobile device and the yield rate in the manufacturing process has become an imminent challenge.

### SUMMARY OF THE INVENTION

It is therefore an object of the invention to provide a mobile device and the display thereof whose internal components are effectively arranged so as to contract the border and further reduce the size of the mobile device.

According to an object of the invention, a display including a substrate, a pixel array and an application specific integrated circuit (ASIC) is provided. The substrate has a display region. The pixel array is formed on the display region by several parallel scan lines and several parallel data lines. The data lines intersect with the scan lines. The ASIC is positioned along an extending direction of the scan lines.

According to another object of the invention, a mobile device including a housing, a display and an operating interface is provided. The housing has an opening. The display includes a substrate, a pixel array and an ASIC. The substrate having a display region is disposed in the housing. The display region is corresponding to the opening. The pixel array is disposed on the display region, and constituted by a plurality of parallel scan lines and a plurality of parallel data lines intersecting the scan lines. The ASIC is positioned along an extending direction of the scan lines. The operating interface is disposed in the housing and corresponding to the ASIC.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a diagram of a conventional display adopting an a-Si manufacturing process;

FIG. 1B is a front view of a conventional mobile device having a display shown in FIG. 1A;

FIG. 2 is a diagram of the conventional display adopting a low-temperature polycrystalline silicon manufacturing process;

FIG. 3 is a front view of the mobile device according to a first embodiment of the invention;

FIG. 4 is a block diagram of a display of the mobile device according to a first embodiment of the invention;

FIG. 5 is a block diagram of a display of the mobile device according to a second embodiment of the invention; and

FIG. 6 is a block diagram of a display of the mobile device according to a third embodiment-of the invention.

### DETAILED DESCRIPTION OF THE INVENTION

The invention provides a mobile device and the display thereof whose design of adopting a single integrated ASIC reduces the operating frequency of thin film transistor (TFT) or even allows the ASIC to be disposed on the same side with the gate driver or the opposite side thereof. The internal components of the display are effectively arranged so as to contract the border and further reduce the size of the mobile device. Despite a number of embodiments are exemplified below, the embodiments, merely examples of the invention, shall not limit the scope of the invention.

### First Embodiment

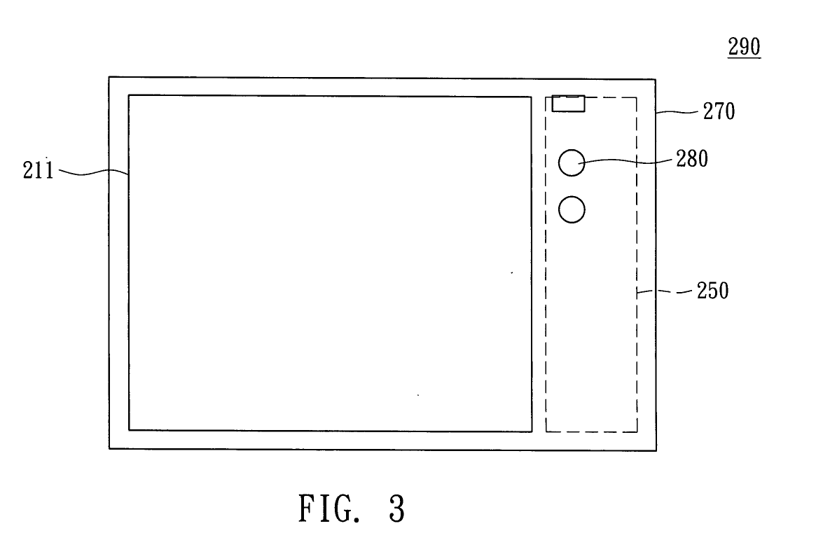

Referring to FIG. 3, a front view of the mobile device according to a first embodiment of the invention is shown. Mobile device 290 at least includes a housing 270, a display and an operating interface 280. The mobile device 290 can be a digital still camera (DSC), a digital video camera (DVC), a mobile phone, or a personal digital assistant (PDA) for instance. The housing 270 of the mobile device 290 has an opening used for exposing a display region 211 of the display. The operating interface 280, which is disposed on the housing 270 and corresponding to an ASIC 250, is used for controlling the display and related settings.

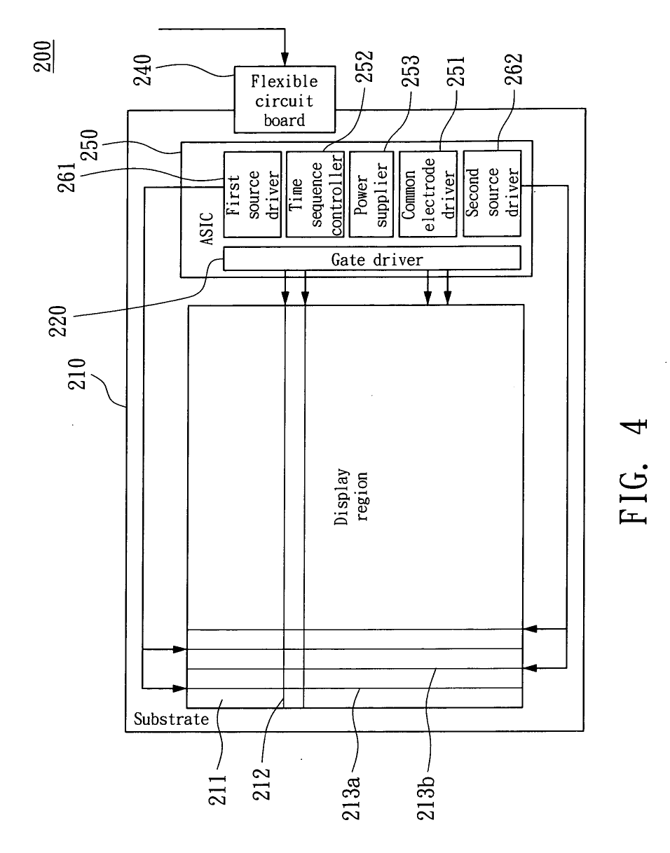

FIG. 4 is a block diagram of a display of the mobile device according to a first embodiment of the invention. The display 200 at least includes a substrate 210, a pixel array and an application specific integrated circuit (ASIC) 250. The substrate 210 having a display region 211 is disposed in the housing. The display region 211 is corresponding to the opening of the housing 270. The pixel array is disposed on the display region 211, and constituted by several parallel scan lines 212 and several parallel data lines 213. The data lines 213 intersect with the scan lines 212; preferably, the data lines 213 are substantially perpendicular to the scan lines 212. The ASIC 250 is disposed along an extending direction of the scan line 212. For example, the ASIC 250 can be positioned at the right-hand side of the display region 211 on the substrate 210 as shown in FIG. 4.

The display 200 further includes a gate driver 220 for driving the scan lines 212. The gate driver 220 is positioned along the extending direction of the scan lines 212. Preferably, the ASIC 250 and the gate driver 220 are disposed on the same side relatively to the display region 211 as shown in FIG. 4. Compared with the disposition of internal components of a conventional display, the display 200 of the present embodiment integrates the gate driver 220 into the ASIC 250, reducing the distance from the display region 211 to the edges of the substrate 210. Meanwhile, without increasing, the volume of the mobile device 290, the boarder of the display can achieve three-edge symmetry, introducing further versatility to exterior design of mobile device.

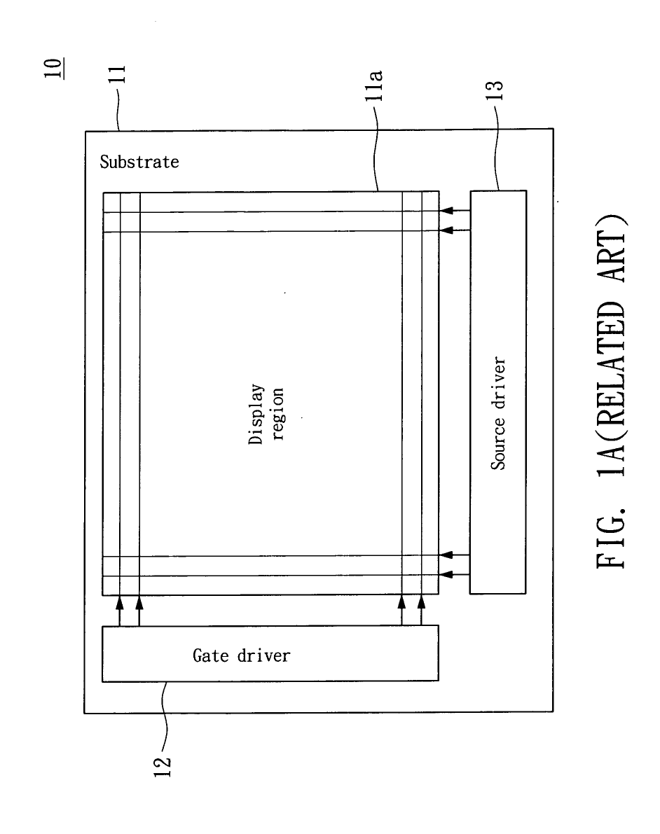

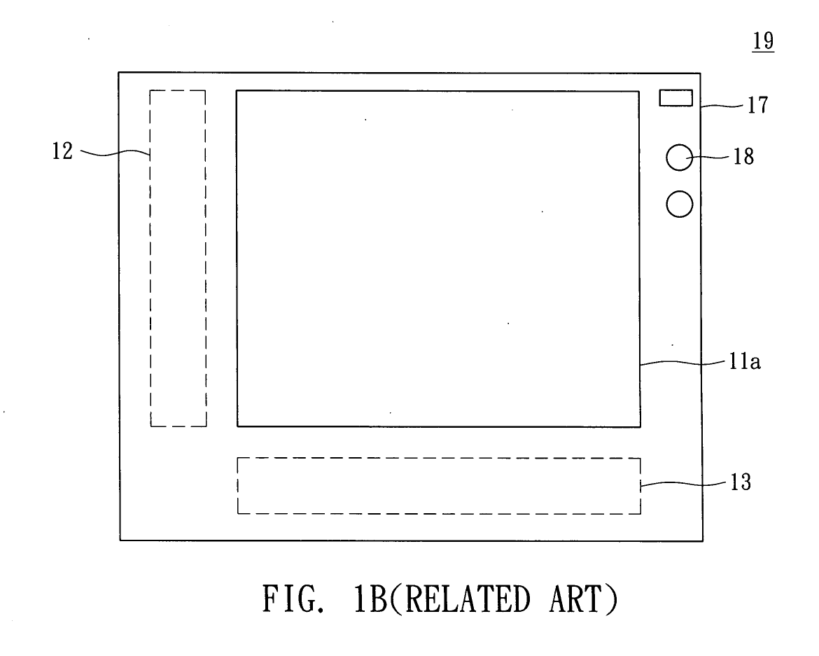

Referring to FIGS. 1B and 3, a comparison is made between the display region 11a and the display region 211 whose sizes are the same. With the gate driver 220 of the present embodiment being integrated into the ASIC 250, the distance from the display region 211 to the edges of the substrate 210 is reduced so as to miniaturize the mobile device and improve product competitiveness.

On the other hand, the display 200 of the present embodiment whose design of adopting single integrated ASIC 250 integrates the source driver, the gate driver and other drive circuits into the ASIC, so that it reduces the cost of the drive circuit. Afterwards, the ASIC 250 is formed on the substrate 210 by the chip on glass (COG) process.

The ASIC 250 includes a source driver. The source driver includes a first source driver 261 and a second source driver 262 which are respectively disposed on two sides of the gate driver 220. When several pixel data are inputted into the ASIC 250 via the flexible circuit board 240, the first source driver 261 and the second source driver 262 respectively output the pixel data to odd-rowed data lines 213a and even-rowed data lines 213b. Meanwhile, the gate driver 220 outputs several scan signals to the corresponding scan lines 212, enabling the gate driver 220 and the source driver to drive the pixel array together.

Besides, the ASIC 250 further includes a common electrode driver 251, a timing controller 252 and a power supplier 253. The common electrode driver 251 is used for outputting a common voltage. The potential difference between the common voltage and the pixel voltage enables a luminous component to generate light spots of various intensities on a display monitor. The timing controller 252 is used for synchronizing and controlling the first source driver 261, the second source driver 262 and the gate driver 220. The power supplier 253 is used for providing the first source driver 261, the second source driver 262, the gate driver 220, the common electrode driver 251 and the time sequence controller 252 with necessary power for operation.

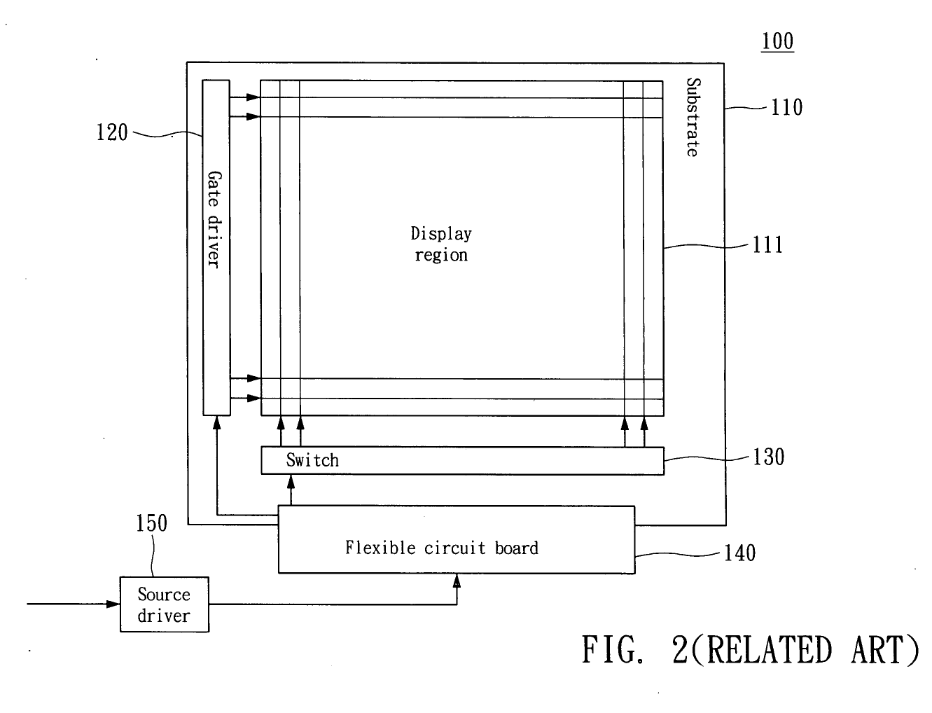

In the mobile device 290 of the present embodiment, the operating interface 280 is disposed on the housing 270 and corresponding to the ASIC 250 as shown in FIG. 2. Preferably, the operating interface 280 is adjacent to the opening of the housing 270, that is, the display region 211 in FIG. 2. Moreover, the operating interface 280 and the ASIC 250 are positioned on the same side relatively to the display region 211. In other word, by correspondingly disposing the ASIC 250 under the operating interface 280, the present embodiment effectively makes use of the remnant space under the operating interface 280 disposed in the mobile device to miniaturize the size of the product.

A digital still camera is taken for instance of the mobile device in the following paragraph. The display monitor of the digital still camera is normally arranged like FIG. 3 when used by a user. That is, the long edge of the display region 211 is disposed along the horizontal direction while the short edge of the display region 211 is disposed along the vertical direction. To be arranged as stated above and give symmetry to three side of the mobile device, the bottom border and the left-hand border of a conventional display monitor must be enlarged as shown in FIG. 1B. Referring to both FIGS. 1B and 3, the disposition of the present embodiment under operating mode rather than enlargement of the border achieves the best utilization of space. By simply rearranging the drivers' position and slightly modifying the routes for connecting drivers, the present embodiment could still follow the existing drivers' circuit, rather than redesign it.

In terms of cost consideration, the drive circuit of the display 200 adopting an a-Si manufacturing process is a single integrated ASIC 250, which costs much less than the non-integrated drive circuit.

### Second Embodiment

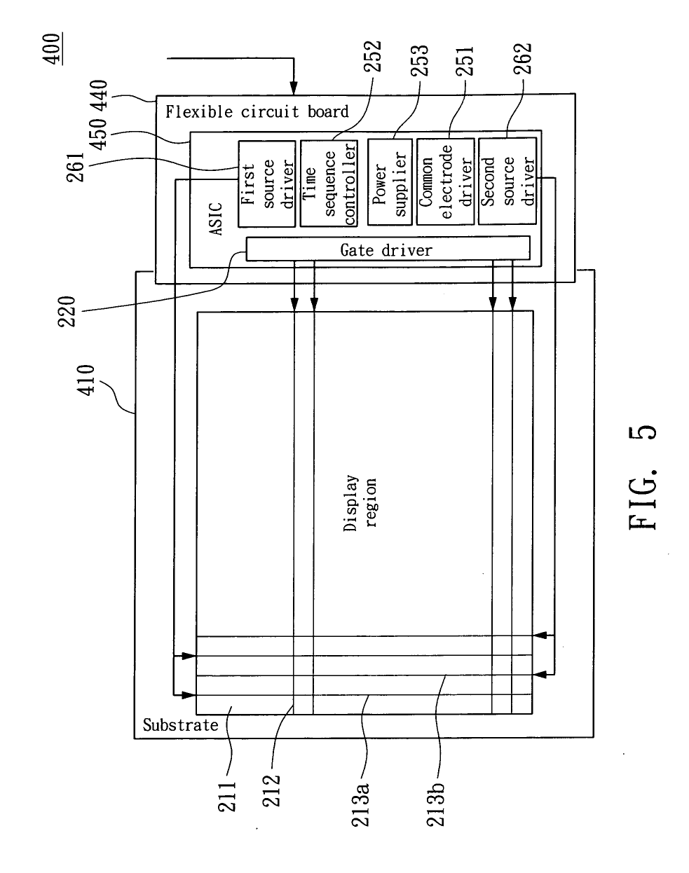

The present embodiment differs with the above embodiment only in the position of the ASIC. As for the remaining components being the same and following the same labeling are not repeated here. FIG. 5 is a block diagram of a display of the mobile device according to a second embodiment of the invention. The display 400 of the second embodiment at least includes a substrate 410, a flexible circuit board 440 and an ASIC 450. The substrate 410 has a display region 211, several mutual parallel scan lines 212 and several scan lines 212 substantially perpendicular thereto. The parallel data lines 213 intersect the scan lines 212, and both data and scan lines 212 and 231 are formed on the display region 211. The ASIC 450 is disposed along an extending direction of the scan line 212. For example, the ASIC 450 can be positioned on the right-hand side of the display region 211, and disposed on the flexible circuit board 440 as shown in FIG. 5. The ASIC 450 is formed on the substrate 410 by the chip on film (COF) process.

Compared with the disposition of the display of the first embodiment, the display 400 of the present embodiment disposes the ASIC 250 on the flexible circuit board 440, further reducing the distance from the display region to the edges of the substrate 410. In addition to the advantages possessed by the above embodiment, the borders of the display 440 further achieve four-edge symmetry by bending the flexible circuit board 440 to the rear side of the substrate 410. It introduces further versatility to exterior design, miniaturizes the size of the mobile device, and enhances product competitiveness.

On the other hand, when several pixel data are inputted into the ASIC 450 via the flexible circuit board 440, the first source driver and the second source driversource drivers 261 and 262 respectively output pixel data to the odd-rowed data lines 213a and the even-rowed data lines 213b on the substrate 410 via the flexible circuit board 440 again. Meanwhile, the gate driver 220 also outputs several scan signals to the corresponding scan lines 212 on the substrate 410 via the flexible circuit board 440, enabling the gate driver 220 and the first and the second source drivers 261 and 262 to drive the pixel array together.

### Third Embodiment

The present embodiment differs with the above first embodiment only in the manufacturing process of the display of the mobile device. However, the position of the gate driver and that of the switch are changed accordingly.

The display of the mobile device of the present embodiment adopts a low-temperature polycrystalline silicon manufacturing process (LTPS), enabling the pixel array and part of the drive circuits to be formed on the substrate at the same time, and miniaturizing the circuits of thin film transistors. Besides, by integrating the ASIC into the substrate and using the 24-PAAT driving method to reduce the operating frequency of the switch, the yield rate in the manufacturing process can be improved, and deterioration caused by operating in high frequency also can be decreased.

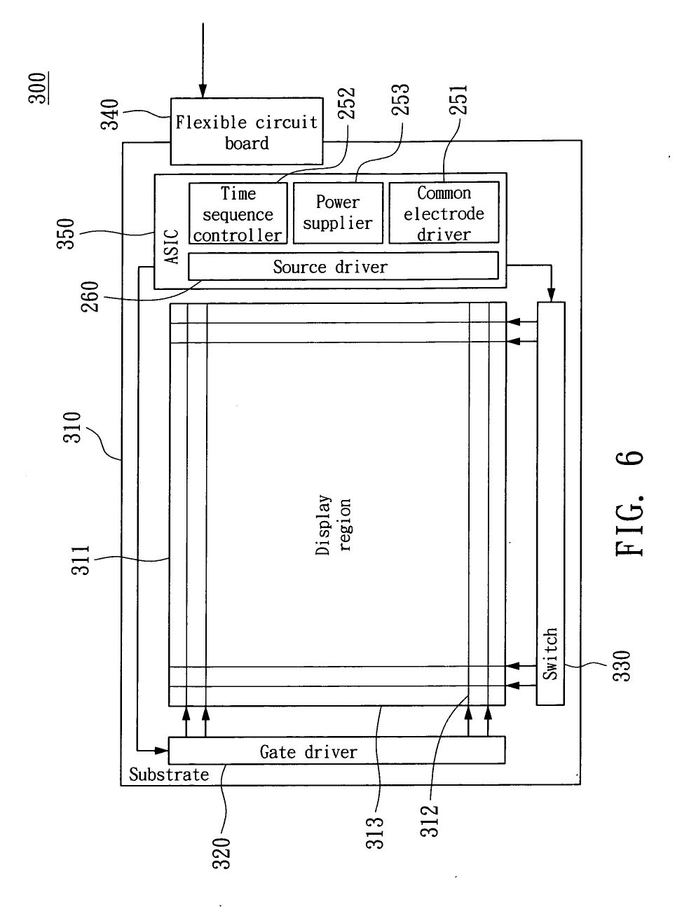

Referring to FIG. 6, a block diagram of a display of the mobile device according to a third embodiment of the invention is shown. The display 300 includes a substrate 310, an ASIC 350, a gate driver 320, a switch 330 and a flexible circuit board 340. The substrate 310 is disposed in the housing. The display region 311 is corresponding to the opening. The pixel array is disposed on the display region 311 by several mutual parallel scan lines 312 and several scan lines 312 substantially perpendicular thereto. The parallel data lines 313 intersect with the scan lines 312. The pixel array further includes several thin film transistors arranged in matrix and correspondingly disposed on the pixel array. The switch 330 is disposed on the substrate 310, and positioned between the source driver 360 and the data line 313. The switch 330 respectively is corresponding to the data lines 313 for selectively driving the data lines 313. The gate driver 320 is formed on the substrate 310. The gate driver is preferably manufactured according to a TFT manufacturing process. For example, the switch 330, the gate driver 360, the data line 313 and the scan line 312 on the display region, and the thin film transistor are formed on the substrate according to a low-temperature polycrystalline silicon (LTPS) manufacturing process. In the LTPS manufacturing process, the Excimer Laser is used as the thermal source. Laser light, through the projection system, would generate Laser beams with uniformed distribution of energy to be projected on an a-Si structure glass substrate. After absorbing energy from the Excimer Laser, the a-Si structure glass substrate would be converted into a polycrystalline silicon structure with high electronic mobility. The gate driver and the switch are directly formed on the substrate without packaging, so the size is contracted and the boarder of the display space is reduced. The flexible circuit board 340 is disposed adjacent the ASIC 350, such as being disposed at the right-hand side of display region 311, to receive external signals. The ASIC 350 includes a source driver 260 used for driving several data lines 313. Preferably, the ASIC 350 and the gate driver 320 are respectively disposed on two opposite sides of the display region 311.

In terms of function, the drive circuit of the display 300 of the present embodiment adopts a low-temperature polycrystalline silicon (LTPS) manufacturing process and is integrated into a single ASIC 350, not only reducing the cost of the drive circuit and the TFT operating frequency of the pixel array, but also increasing the yield rate in the manufacturing process of thin film transistors.

The mobile device and the display thereof disclosed in the above embodiment of the invention whose design of adopting a single integrated ASIC to be disposed on the same side with the gate driver or to the opposite side thereof and making effective space utilization of the drive circuit inside display. It reduces the distance from the display region to the edges of the substrate, and contracts the boarder of the display. Besides, the display according to the first embodiment of the invention whose design of adopting single integrated ASIC to drive the pixel array makes effective use of the space utilization of the drive circuits inside the display reduces the distance from the display region to the edges of the substrate and contracts the boarder of the display. The display according to the second embodiment of the invention whose design of disposing the ASIC on the flexible circuit board largely reduces the area of the display and achieves four-edge symmetry of the four border of the display. On the other hand, the display according to the third embodiment of the invention forms part of the drive circuits such as the switch and the gate driver on the substrate with the pixel array in the same LTPS process. Therefore, a smaller amount of area for accommodating the drivers is required, and the border space is saved. Meanwhile, by adopting a single integrated ASIC and using a 24-PAAT drive structure to drive the pixel array, not only the operating frequency of the pixel array but also the yield rate in the manufacturing process of thin film transistor can be increased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so, as to encompass all such modifications and similar arrangements and procedures.

What is claimed is:

1. A display, comprising:
a substrate having a display region;
a pixel array disposed on the display region and constituted by a plurality of parallel scan lines and a plurality of parallel data lines intersecting the scan lines; and
an application specific integrated circuit (ASIC) positioned along an extending direction of the scan lines.

2. The display according to claim 1, wherein the ASIC is disposed on the substrate.

3. The display according to claim 1, further comprising a gate driver for driving the scan lines.

4. The display according to claim 3, wherein the gate driver is positioned along the extending direction of the scan lines.

5. The display according to claim 4, wherein the ASIC and the gate driver are disposed on the same side of the display region.

6. The display according to claim 5, wherein the gate driver is integrated into the ASIC.

7. The display according to claim 6, wherein the ASIC is formed on the substrate by a chip on glass (COG) process.

8. The display according to claim 6, wherein the ASIC comprises a source driver having a first source driver and a second source driver disposed on the two sides of the gate driver, respectively.

9. The display according to claim 1, wherein the display further comprises a flexible circuit board positioned along the extending direction of the scan lines, and the ASIC is disposed on the flexible circuit board.

10. The display according to claim 9, wherein the ASIC is formed on the substrate by a chip on film (COF) process.

11. The display according to claim 3, wherein the ASIC and the gate driver are disposed on the two opposite sides of the display region, respectively.

12. The display according to claim 11, wherein the display panel further comprises a switch disposed on the substrate and positioned between the source driver and the data lines, the switch corresponding to the respective data lines for selectively driving the data lines.

13. The display according to claim 11, wherein the ASIC comprises a source driver for driving the data lines.

14. A mobile device, comprising:
a housing having an opening;
a display of claim 1, wherein the substrate of the display is disposed in the housing, and the display region is corresponding to the opening; and
an operating interface disposed on the housing and corresponding to the ASIC.

15. The mobile device according to claim 14, wherein the ASIC is disposed on the substrate.

16. The mobile device according to claim 14, wherein the operating interface is adjacent to the opening while the operating interface and the ASIC are positioned on the same side of the display region.
